(19) United States
(12) Patent Application Publication
(10) Pub. No.: US 2026/0016427 A1
(43) Pub. Date: Jan. 15, 2026

(54) METHOD AND SYSTEM FOR ACTIVATION ANALYSIS

(71) Applicant: Chrysos Corporation Limited, Tonsley, South Australia (AU)

(72) Inventor: James Tickner, Tonsley (AU)

(73) Assignee: Chrysos Corporation Limited, Tonsley, South Australia (AU)

(21) Appl. No.: 19/128,277

(22) PCT Filed: Nov. 9, 2023
(86) PCT No.: PCT/AU2023/051131

§ 371 Date: May 8, 2025

(30) Foreign Application Priority Data
Nov. 9, 2022 (AU) 2022903345

(51) Int. Cl. G01N 23/222; G01N 23/2202

(52) U.S. Cl. CPC G01N 23/222; G01N 23/2202; G01N 2223/0745

(57) ABSTRACT

There is described herein a method for preparation of an at least partially liquid sample for activation analysis. The method may comprise placing the sample containing at least one target element in a container and solidifying the sample within the container. There is also described herein a method and a system for performing neutron or gamma activation analysis. The method may comprise providing an at least partially liquid sample containing at least one target element. The sample is solidified. The solidified sample is irradiated to activate at least one target element within the sample. The number of gamma rays emitted by the at least one target element may be measured. A value representative of the concentration of the at least one target element in the sample may be determined utilising the measurement of gamma rays emitted by the at least one target element and a calibration determined from a solid sample of known composition.

### TECHNICAL FIELD

The present disclosure relates generally to a method or system for activation analysis of a liquid sample for the determination of the concentration of one or more target elements within the sample. The present disclosure also relates to a method of preparation of the liquid sample.

### BACKGROUND

Neutron activation analysis (NAA) and gamma activation analysis (GAA), also known as photon activation analysis, are methods for measuring the elemental composition of samples of material where the composition is otherwise unknown. In particular, activation analysis is useful in determining the concentration of desirable target elements in a sample. The sample is irradiated with either a beam of neutrons or high-energy X-rays produced by an X-ray source. The irradiation of the sample in this manner will induce nuclear transitions within at least one target element which can lead to the formation of radioisotopes.

After a period of irradiation, the sample is placed in proximity to one or more gamma-ray detectors. The induced radioisotopes in the sample decay with a characteristic half-life and may emit gamma-rays with one or more characteristic energies. The gamma-ray detector(s) counts the gamma-rays emitted from the sample and measures their energies. The number of gamma-rays emitted from a target element is proportional to the quantity of that element in the sample.

For many applications including mineral exploration, mining and mineral processing, for samples such as mineral ore, it is advantageous to measure a large volume of material to ensure that the sample is representative. Such large samples are particularly prone to the effects of spatial sensitivity dependence. To improve sensitivity of the apparatus it is advantageous to position the irradiation source close to the sample during irradiation and gamma-ray detectors close to the sample during gamma-ray detection. For example, for the measurement of gold present in a mineral ore at a concentration of a few parts-per-million or below, a 0.5 kg sample may be conveniently measured in a cylindrical container with a diameter of about 100 mm and a height of about 50 mm. The irradiation source and detectors may be positioned as close as practicably possible to the outer surfaces of the jar and hence to the mineral ore sample.

The radiation flux from a point source, ie radiation source, is reduced with the square of the distance from the source, and the radiation flux is further reduced due to attenuation of the incident beam by material within the sample. Thus, the flux from a radiation source positioned in proximity to the surface of a cylindrical sample will be highly nonuniform. Irradiating the sample from one side whilst rotating the sample can improve the flux uniformity, but some regions of the sample will still be exposed to higher fluxes of incident radiation than other regions. Consequently, atoms of the target element(s) in the high-flux regions have a higher probability of being activated by the incident radiation than target atoms in lower-flux regions.

In a similar manner, the probability of detection of a gamma-ray emitted by a radioisotope formed during the activation process is reduced approximately with the inverse square of the distance of the atom from the radiation detector. The probability of detection is further attenuated by absorption of the gamma-rays inside the sample material. For lower-energy gamma-rays, the attenuation inside the sample may be comparatively significant.

The probability of detecting an atom of a target element is then given by the product of the activation rate per atom, which is dependent on the incident radiation flux at the location of the atom, and the gamma-ray detection probability. The overall instrument sensitivity to a given target element is given by integrating the position-dependent detection probability over the volume of the sample material.

A calibration method, such as using calibration software, may be used to calculate the concentration of the activated element(s) from the measured intensities of their characteristic gamma-ray emission. Unless the sample size is very small, both the intensity of the activating neutron or X-ray beam, and the efficiency for detecting the characteristic gamma-rays, vary with position throughout the sample volume. Spatial sensitivity dependence needs to be accounted for by the calibration method or software. Typically, the calibration will utilise measurements of standard samples having an already accurately known composition and accurately known quantity of a target element.

Samples may take different physical forms, such as solid materials (including powders or chips), liquids, or mixtures of solid materials and liquids (slurries). Solid samples can be assumed to be immobile. Thus, for a solid sample the position of any given target atom during irradiation and during measurement is the same. Liquids and slurries are mobile samples in the sense that their elements are in motion and not static, including during an irradiation or detection process. For example, movement of the sample into the irradiation apparatus, and between the irradiation and detection apparatuses will generally lead to motion of the liquid. Additionally, the significant heating that can occur when a liquid sample is presented to an intense source of incident radiation can lead to convection within the liquid sample.

Therefore, the instrument sensitivity for a liquid or slurry sample will not be the same as for a solid sample and a calibration method developed for immobile solid samples cannot be directly applied to the measurement of mobile samples such as slurries or liquids. That is, the motion of the activated elements within the liquid or slurry sample volume during irradiation, or between irradiation and measurement, will affect the relationship between measured characteristic gamma-ray intensity and element concentration. There is, therefore, a difficulty in obtaining calibrated measurements of liquid or slurry samples.

The variation in instrument sensitivity is inconvenient as it means that separate calibrations must be maintained for different sample types (solid or liquid). In addition, if liquid samples with different properties, including density, heat capacity or viscosity, are to be measured then separate calibrations for each variation of the liquid properties may be needed, and specifically if the motion of the liquids during irradiation, measurement or transfer between the two processes differs.

Although a separate method for obtaining a calibrated measurement of the concentration of elements in each sample type could be devised, the maintenance of multiple calibrations is inconvenient, particularly in a commercial laboratory environment, as it can be time consuming and also necessitates separate quality control standards and validation. Furthermore, it is an inconvenience that the sample type must be correctly identified for every analysis performed, including for a liquid or slurry sample the relevant properties of the sample, which imposes yet further record keeping and data quality checking requirements.

One approach to solving the current problem is described by Burmistenko et al in SU464224. They propose that the sample be made cylindrical in form and irradiated from one side through its curved surface. The sample is then rotated about its cylindrical axis during irradiation. During measurement, the sample is positioned between two cylindrical detectors such that the axes of both detectors and the sample are the same. The intention of this configuration is to try and ensure that both the incident flux and the gamma-ray detection probability are as uniform as possible throughout the sample volume. If both flux and detection probability were completely uniform, then the probability of detecting a target atom would be independent of its position and consequently the overall instrument sensitivity will be the same for both mobile and immobile samples. However, only limited uniformity of both flux and detection probability can be achieved using this approach and it has proven not to be satisfactory.

Another approach, is to reduce the dimensions of the sample. For example, when performing thermal neutron activation analysis, it is common to reduce the sample size to a minimum (a few grams or less) so that the sample can be assumed to have no perturbing influence on the incident neutron flux. Similarly, a small sample size leads to negligible internal attenuation of gamma-rays emitted from the sample. Further, if the sample is positioned at a distance from the gamma-ray detectors that is large compared to the sample size, the gamma-ray detection probability throughout the sample volume become uniform. This approach is undesirable due to its reliance on very small sample sizes. Such a small sample size is at odds with the requirement for a large sample mass in many applications. Reasons that larger sample sizes may be desirable include reducing sampling errors and increasing sensitivity to elements present at low concentrations within a sample. For example, where the sample material is a portion of mineral ore containing low concentrations of a valuable metal such as gold, measuring a larger mass of material reduces sampling errors and improves precision. Introducing a large separation between the sample and gamma-ray detectors also reduces the sensitivity.

Another difficultly of measuring large liquid samples via NAA or GAA arises if the sample containers are ruptured during analysis. For example, the containers may be dropped during loading, have their lids incorrectly fitted by an operator or be inadvertently raptured by an automated sample handling system. A ruptured container of a liquid or slurry material is likely to spill which, as well as rendering the sample no longer available for analysis, poses several risks. First, the liquid may contaminate parts of the analysis apparatus, potentially affecting the measurement of subsequent samples. Second, samples may be toxic, caustic or acidic. For example, gold containing solutions used in mineral processing may also contain amounts of cyanide or have a very low pH. Third, samples spilled after activation can be radioactive and may pose health risks to any persons in the vicinity, including those tasked with cleaning up the spillage.

It is therefore desirable to provide a method or system which overcomes, mitigates or provides a useful alternative to at least one of the problems associated with the prior art.

### SUMMARY

According to an aspect of the present disclosure, there is provided a method for performing neutron or gamma activation analysis, comprising: providing a sample, the sample being at least partially liquid and containing at least one target element; solidifying the sample; irradiating the sample to activate the at least one target element within the sample; detecting a number of gamma rays emitted by the at least one target element within the sample in a measurement; determining a value representative of the concentration of the at least one target element in the sample utilising the measurement of gamma rays emitted by the at least one target element and a calibration determined from a solid sample of known composition.

According to embodiments, the sample is solidified using a gelling or setting agent. The gelling or setting agent may include one or more of a superabsorbent polymer, polyacrylate or polyacrylamide. The gelling or setting agent preferably comprises sodium polyacrylate. According to embodiments, the gelling or setting agent comprises one or more of fumed silica, calcium sulphate, calcium sulphate hemihydrate or a cement. According to other embodiments, the sample is solidified through a freezing process.

According to embodiments, the at least partially liquid sample is in the form of a liquid, or is a liquid sample. According to embodiments, the at least partially liquid sample may comprise a slurry or process solution. The slurry or process solution may be from a mineral processing plant.

According to embodiments, the sample is irradiated by a source of X-rays. The source of X-rays may be a solid metal target on which a beam of electrons impinge. The source of the beam of electrons may be a linear accelerator (LINAC). The solid metal target produces X-rays with an energy of up to the energy of the beam of electrons. The LINAC may accelerate the electrons at an energy of above 5 MeV. The LINAC may accelerate the electrons at an energy of about 8 MeV to about 14 MeV. The LINAC may accelerate the electrons at an energy of about 8 MeV. The electron beam energy may be selected in dependence on the target element(s) within the sample, the concentration of which are to be determined. The LINAC may comprise the solid metal target. The electrons may be rapidly slowed down by the solid metal target to produce a continuous energy spectrum of X-rays with a maximum energy corresponding to the energy of the electron beam.

According to another embodiment, the sample is irradiated by a source of neutrons. The source of neutrons may be a radioisotope source such as californium-252 or an admixture of americium-241 and beryllium. The source of neutrons may be a sealed-tube neutron generator that accelerates deuterium or tritium ions onto a target containing additional deuterium or tritium, thereby producing neutrons via DD or DT fusion reactions. The source of neutrons may be an ion beam accelerated to impinge on a metal target. The source of neutrons may be an electron beam from a linear accelerator that impinges on a metal target, where the electron energy is greater than the neutron separation threshold of at least one isotope constituting the target. The source of neutrons may include a moderator to increase the flux of thermal neutrons in the sample. Elements in the sample may be activated by either fast-neutron reactions such as (n,n′), (n,2n) and (n,p), or by the thermal neutron capture reaction (n,g).

According to embodiments, the sample is placed in a container prior to solidification. According to embodiments, the solidified sample is irradiated when contained in the container. According to embodiments, the container is substantially cylindrical. The container may be a jar. The container may be formed from a plastic or polymer material. The container may include a lid. The lid may be removably attached to the container body via a screw fastening mechanism. The container may have a diameter in the range from about 50 mm to about 100 mm. The container may have a height in the range from about 40 mm to about 70 mm. The container may have a volume of about 100 mL to 1 Litre, or about 200 mL to about 500 mL, or about 300 mL. The container may hold a sample mass of about 100 g to 1 kg, or about 300 g.

According to embodiments, the method further includes irradiating the reference material to activate a reference element within the reference material, the reference element having a known concentration within the reference material; detecting a number of gamma rays emitted by the reference element; and normalising the measurement of emitted gamma rays from the at least one target element by using the detected number of gamma rays emitted by the reference element, wherein determining the value representative of the concentration of the at least one target element utilises the normalised measurement.

According to embodiments, the sample and reference material are irradiated simultaneously. The sample and reference material may be positioned adjacent to one another prior to irradiation. According to embodiments, the sample and reference material may be placed in respective containers and positioned adjacent to one another.

According to embodiments, the reference material takes the form of a disc or circular sheet. The reference material may be in a cylindrical shape. The reference material may have a thickness of 0.1-3.0 mm. The reference material may have a diameter substantially similar to or smaller than the diameter of the container containing the sample. The diameter of the reference material may be about 50 mm to about 100 mm. During irradiation and measurement, the reference material may be positioned on one flat face of the container, such that a central axis of the reference material coincides with a central axis of the container.

According to another aspect of the disclosure, there is provided a method for preparation of an at least partially liquid sample for neutron or gamma activation analysis, comprising: placing the at least partially liquid sample in a container, the sample comprising at least one target element; and solidifying the sample within the container.

According to embodiments, the sample is solidified using a gelling or setting agent. The gelling or setting agent may include one or more of a superabsorbent polymer, polyacrylate or polyacrylamide. The gelling or setting agent preferably comprises sodium polyacrylate. According to embodiments, the gelling or setting agent comprises one or more of fumed silica, calcium sulphate, calcium sulphate hemihydrate (plaster of Paris) or a cement. According to other embodiments, the sample is solidified through a freezing process.

According to embodiments, the at least partially liquid sample comprises a slurry or process solution. The slurry or process solution may be from a mineral processing plant.

According to embodiments, the container is substantially cylindrical. The container may be a jar. The container may be formed from a plastic or polymer material. The container may include a lid. The lid may be removably attached to the container body via a screw fastening mechanism. The container may have a diameter in the range from about 50 mm to about 100 mm. The container may have a height in the range from about 40 mm to about 70 mm. The container may have a volume of about 100 mL to 1 Litre, or about 200 mL to about 500 mL, or about 300 mL. The container may hold a sample mass of about 100 g to 1 kg, or about 300 g.

According to embodiments, a sample holder may hold the sample. The sample holder may hold the container which contains the sample. The sample holder may hold the reference material in a fixed relationship to the sample. The sample holder may be moveable and/or operable to be shuttled between an irradiation system and a detector system. The sample holder may be moveable between a solidification system where the sample is solidified and the irradiation system.

Another aspect of the present disclosure provides a system for performing neutron or gamma activation analysis on an at least partially liquid sample, the system comprising: depositing the at least partially liquid sample in a container, the at least partially liquid sample comprising at least one target element; a solidification station where the at least partially liquid sample is solidified in the container to create a solidified sample; an irradiation station where the solidified sample is irradiated and the at least one target element undergoes activation; a detection station where a number of gamma rays emitted by the activated target element(s) in the solidified sample are measured; and a calculation system which utilises the measured number of gamma rays emitted by the target element(s) and a calibration determined form a solid sample of known composition to determine a value representative of the concentration of each target element within the sample.

The above system may comprise any one or more features of the method according to any other aspect or embodiment described herein.

According to embodiments, the system comprises a sample holder adapted to hold the sample container. The sample holder may hold a reference material in a fixed relationship relative to the sample.

According to embodiments, the system comprises a sample transport configured to move the sample between the solidification station and the irradiation station. According to embodiments, the system comprises a sample transport configured to move the sample between the irradiation station and the detection station. According to embodiments, the sample transport is configured to move the sample between each of the solidification station, irradiation station and the detection station. According to embodiments, the sample holder holds the sample during movement by the sample transport.

According to embodiments, the at least partially liquid sample is solidified by the addition of a gelling agent or a setting agent. The gelling agent or the setting agent may comprise a superabsorbent polymer, a polyacrylate or a polyacrylamide. Either a fixed mass or fixed volume of gelling agent or of the setting agent may be added sufficient to solidify the volume of liquid constituting the sample. The gelling agent or the setting agent may comprise sodium polyacrylate.

According to embodiments, the system further comprises a reference material comprising a reference element. The reference material may be positioned adjacent to the sample container when at the irradiation station and when at the detection station. The reference material may be held in a fixed relationship relative t to the sample by a sample holder. The calculation system may utilise a measurement of gamma rays emitted by the reference element in the determination of the value representative of the concentration of each target element within the at least partially liquid sample.

According to embodiments, the system comprises a computer configured to control a functioning of at least one of the solidification station, irradiation station, detection station and sample transport. The computer may control the movement of the sample between the solidification station, irradiation station and detection station. The computer may control a beam of electrons emitted by a linear accelerator at the irradiation station. The computer may control at least one detector at the detection station. The computer may receive the measurement(s) from the detector(s). The computer may comprise the calculation system. The computer may control a solidification of the at least partially liquid sample. For example, the computer may control the addition of fixed mass or a fixed volume of a setting agent or of a gelling agent to the at least partially liquid sample. The computer may control waiting for a prescribed period of time for the setting or gelling process to complete. The computer may control affixing the lid to the sample container.

According to embodiments, the irradiation station comprises a linear accelerator that generates a beam of high energy electrons and a solid metal target that produces X-rays when the beam of electrons impinges on a surface of the solid metal target.

According to embodiments, the detection system comprises at least one radiation detector. The at least one detector may be a high-resolution detector. The at least one detector may be a semiconductor detector. The at least one detector may be a scintillator detector. The detector may be a solid-state detector, for example formed from hyper-pure germanium. The at least one detector may comprise two detectors configured to be positioned on opposite sides of the sample container in use. The or each detector may be cylindrical.

The methods provided herein may provide any one or more of the following advantages:
a) Measurement of the concentration of elements in liquid sample or at least partially liquid sample can be performed utilising the same systems, apparatus and methods as have been previously devised for solid samples. This means that a single calibration can be applied to samples of all types which may simplify the overall process and prevent the need for recalibration of the instruments.
b) Precision, accuracy and convenience when measuring the concentrations of target elements within an at least partially liquid sample through neutron or gamma activation analysis can be improved.
c) Spillage of at least partially liquid sample(s), such as from damaged or dropped containers, can be avoided by solidifying the sample(s). This is particularly useful where the sample(s) may contain potentially toxic or hazardous substances.

The intended application of methods according to the present disclosure is the analysis of liquid samples or partially liquid samples using an instrument designed for the measurement of large solid samples. The proposed methods are particularly useful for measurement of gold, silver, copper and other valuable metals via gamma activation analysis in solutions, slurries or liquids from mineral processing, waste recycling and other extractive operations.

### Definitions

As used herein the term ‘liquid sample’ is used to refer to any sample which is mobile and has a largely liquid constituent. The liquid sample may have a low viscosity and may be very fluid, alternatively the liquid sample may be highly viscous and less fluid although still a mobile substance. The liquid sample may have solid component, such as solid particles or a sediment within the liquid. The liquid sample in some embodiments may be a slurry or process solution, such as may be obtained from a mineral processing plant or mining operation. The liquid sample may comprise a liquid body containing at least one target element within the body. Any reference to an ‘at least partially liquid sample’ herein encompasses an entirely liquid sample, a substantially liquid sample and a partially liquid sample.

As used herein the terms ‘solidify’, ‘solidification’ or ‘solidified’ refer to the act of converting a liquid substance to a substantially solid, immobile substance or to the resulting substance that has undergone this conversion. The solidified substance will be immobile such that the elements within the solidified substance are not in motion and have a substantially fixed position that is not altered by application of a heat or movement of the substance as a whole. The solidified substance may be a hardened gel substance or a set substance, as examples.

### BRIEF DESCRIPTION OF DRAWINGS

Embodiments of the invention will now be described with reference to the accompanying drawings. It is to be understood that the embodiments are given by way of illustration only and the invention is not limited by this illustration. In the drawings:

FIG. 1 is a schematic drawing representing an apparatus configured to carry out gamma activation analysis of a sample; and

FIG. 2 is a chart showing a comparison of measured and certified grades of gold for six samples prepared from certified standard solutions.

### DETAILED DESCRIPTION

According to embodiments of the present disclosure, a liquid sample is obtained. The liquid sample may be a slurry or process solution according to some embodiments, such as may be obtained from a mineral processing plant or mining operation.

According to the methods of the present disclosure, the liquid sample is solidified prior to activation of the element(s) within the sample. Solidification of the sample will transform the liquid sample which is a mobile material to a solidified sample which is an immobile material. Solidification of the liquid sample can take place by any desired method, some of these methods may be preferable or advantageous over other methods. The act of solidifying the liquid sample may also be termed as immobilisation of the sample.

One method for solidification of the liquid sample is to freeze the sample. This method would involve subjecting the liquid sample to a low temperature to cause the liquid to freeze and solidify. Freezing the liquid sample to immobilise it may be a slow process and it may take up to several hours to achieve a solidified frozen sample. It may be desirable to provide methods of solidifying the sample that can immobilise the sample more quickly than freezing the sample. In addition, freezing the sample carries the additional risk that frozen liquid will expand and expansion of the sample within a container can lead to damage or fracturing of the container. Freezing the sample for immobilisation may not be the most desirable method to be used, but may still overcome problems of the prior art and may prevent the need for recalibration of equipment where a sample is initially mobile or liquid.

Other methods of immobilising the liquid sample involve adding a setting agent or a gelling agent to the liquid sample to cause a solidification of the sample. Setting agents used in the method may include cement, plaster of Paris, also known as calcium sulphate hemihydrate or gypsum plaster, or other similar gypsum materials such as calcium sulphate dihydrate. These types of setting agents may take at minimum several minutes and up to several hours to set. It may be preferable that a setting agent or gelling agent will set in less than a few minutes so that the sample may be sent for irradiation of the activation analysis process more quickly. Other Gelling or setting agents suitable for the methods herein can include fumed silica or a cement.

A preferred method of the inventor is to use a gelling agent to immobilise a liquid sample prior to being subjected to activation analysis. Fumed silica is one type of gelling agent that may be suitable for use in the present methods. The gelling agent may include a superabsorbent polymer, polyacrylate or polyacrylamide. Sodium polyacrylate can be added to a liquid sample and may solidify the sample within a matter of a few seconds. Sodium acrylate is also non-toxic, relatively inexpensive and readily available to obtain. As an example, addition of 20 g of sodium polyacrylate to 300 mL of liquid sample results in formation of a firm, immobile gel in less than one minute. The inventor has established that samples set in this fashion can be exposed to intense X-ray radiation, heat and vigorous motion without reverting to liquid form. Once immobilised or gelled, elements in an initially liquid sample can be subjected to activation analysis and readily measured using the same calibration developed for solid materials. Only standard corrections for sample mass and radiation attenuation may be required.

It is desirable that any setting agent or gelling agent used to solidify a liquid sample does not include any amounts of the target element(s) that is the subject of activation analysis. For example, a presence of a target element in the setting or gelling agent may cause the calculated value of concentration of that target element through activation analysis to be increased compared to the use of a setting agent or gelling agent that does not contain that target element. It may also be desirable that the setting agent or gelling agent used does not include any reference element of a reference material used so as to ensure that the normalisation of the target element concentration(s) is not affected.

According to the embodiments of the present invention, a liquid sample is placed in a container. The liquid sample is then solidified/immobilised within the container. For example, a setting agent or gelling agent, such as discussed above, is added to the liquid sample in the container such that the sample will solidify within the container. The sample preferably remains in the same container for the steps of activation by irradiation and then gamma ray detection in the activation analysis process.

As an example, the container may be a cylindrical plastic jar with a screw top. The liquid sample may be placed into the container, the liquid sample is then immobilised, such as through the addition of a setting agent or gelling agent, and the top can be screwed onto the jar to contain the solidified liquid sample. Optionally, a sealing component such as a pressure-sensitive disc or induction sealing foil with diameter substantially equal to that of the jar aperture may be introduced under the screw top to further contain the solidified sample. Jars with a volume of about 300 ml are capable of containing up to about 500 g of typical gold-bearing ores, or about 300 g of typical gold-bearing process solution. The diameter of the jar may be in the range 50-100 mm, and the height of the jar may be in the range 40-70 mm.

PCT publication no. WO2015/089580(A1) of the present inventor relates to a method for rapid analysis of a target element within a sample via gamma activation analysis. Said publication describes improved accuracy in determining the concentration of the target element in the sample by simultaneously irradiating the sample and a reference material containing a reference element of known quantity with X-rays. Optionally, the liquid sample according to the present disclosure once solidified may be subjected to an activation analysis process using the same or similar apparatus as discussed in WO2015/089580(A1). The entire contents of WO2015/089580(A1) is included herein by reference.

PCT publication no. WO2022/047537(A1) of the present inventor relates to improvements in gamma-activation analysis measurements and describes methods and systems for determining a corrected concentration of one or more target elements in a sample by simultaneously irradiating a reference material containing at least two reference elements with X-rays. The at least two reference elements have a variation in activation rate over a pre-defined X-ray end-point energy range that differs from one another. Optionally, the liquid sample according to the present disclosure, once solidified, may be subjected to an activation analysis process as described in WO2022/047537(A1). The entire contents of WO2022/047537(A1) is included herein by reference.

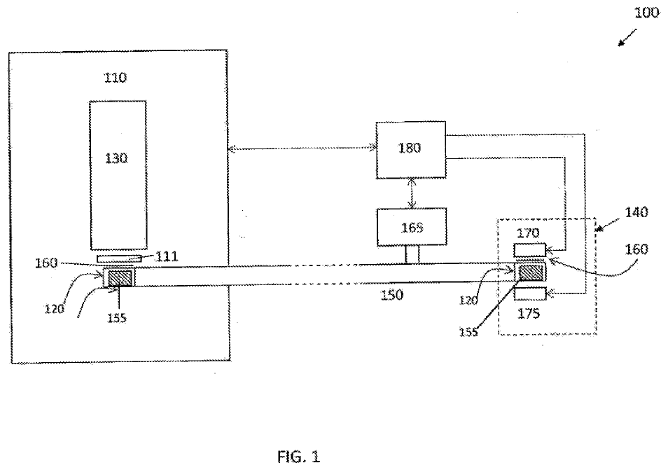

FIG. 1 shows a schematic drawing of an apparatus 100 for gamma activation analysis of a sample 155. The sample 155 is a liquid sample that has been solidified, for example through any suitable method as discussed above. According to this example the target element is gold but could be any other element. The apparatus includes a sample holder 120 to hold each sample 155.

An irradiation system 130 is used to irradiate the solidified liquid sample 155, a detector system 140 is used to detect and quantify the intensity of characteristic decay products, and a transport system 150 to move the sample holder 120 between the irradiation system 130 and the measurement/detector system 140. The sample holder 120, holding the sample 155, is operable to be shuttled or otherwise transported between the irradiation system 130 and the measurement/detector system 140. As noted above, a solidified liquid sample 155 to undergo activation analysis may be packaged in a container such as a cylindrical plastic jar with a screw top.

The solidified liquid sample material 155 is irradiated with X-rays. The sample 155 and/or container holding the sample material 155 may have at least one flat surface. The process material may be irradiated with X-rays through one of the flat surfaces. The irradiation system 130 includes a linear electron accelerator (LINAC) which is substantially enclosed in a radiation shielding 110. The linear electron accelerator accelerates a beam of electrons to an energy of about 8 MeV which then impinge on a solid metal target 111 that converts the electrons' energy into X-rays. The electrons are then rapidly slowed down to produce a continuous energy spectrum of X-rays with a maximum energy corresponding to the electron beam energy. The position of the electron beam on the solid metal target may be scanned during the process of irradiating the sample, to maximise the uniformity of the X-ray flux passing through the sample container. The sample container is placed as close as conveniently possible to the outer surface of the X-ray conversion target.

PCT publication no. WO2018/232435(A1) of the present applicant relates to a shielded x-ray radiation apparatus. The shielding structure and apparatus described in WO2018/232435(A1) may be utilised in the present methods and systems including as radiation shielding 110. The entire contents of WO2018/232435(A1) is included herein by reference.

When the sample 155 has been irradiated for a sufficient length of time, the irradiation system is turned off. The sample holder 120 is then rapidly moved by means of the transport system 150 to the detector system 140 for analysis. The transport system 150 is operated under control of a control system 165. The control system 165 is in turn is under control by means of a computer 180 which is also responsible for controlling the operation of the linear accelerator 130 and the gamma-ray detectors 170, 175.

Prior to activation, the liquid sample is solidified. The solidification of the liquid sample may occur at a solidification station (not shown). The sample may be held in a container, such as the cylindrical plastic jar mentioned above. The liquid sample is then solidified, such as through the addition of a setting or gelling agent in a manner as previously mentioned. The lid or cap may then be affixed to the container. After a sufficient period of time for the liquid sample to solidify and immobilise, the sample is moved to the irradiation system. The sample may be moved to the irradiation system from the solidification system by a transport system which may be part of or similar to the transport system 150 mentioned above. The sample may be held in the sample holder after solidification has occurred or during solidification of the liquid sample. The transport system 150 may be a shuttle system comprising a track and carriage that travels on the track. Alternatively, the transport system 150 could utilise any suitable movement apparatus, including a pulley system or a conveyor belt system. According to other embodiments, the sample 155 may be solidified within the container and then manually or robotically maneuvered into position at the irradiation system, including placement on the sample holder 120.

A pair of high-resolution detectors 170, 175 may be used to measure the activation of the sample 155. In other words the detectors 170, 175 may measure the gamma rays emitted by the sample. The respective detectors 170, 175 may be cylindrical. The detectors 170, 175 may be of similar or larger diameter than the sample container, and may be placed just far enough apart to admit the sample container for measurement therebetween. In this embodiment, the detectors 170, 175 are large-area semiconductor devices, with a FWHM resolution at 279 keV of 1.5 keV or better. It is appreciated that other detectors as known to those skilled in the art could be used, including but not limited to scintillation detectors. According to other embodiments there may be a different detector arrangement than that shown in FIG. 1. For example, there may only be a single detector, or there may be more than two detectors, and/or the detectors may be a shape other than cylindrical. In particular, the detector arrangement shown in FIG. 1 having detectors 170, 175 may be suitable for detection of gamma rays emitted by both sample 155 and optional reference material 160. The detector arrangement utilised according to the present invention in embodiments when no reference material 160 is used may be the same as or different to that shown in FIG. 1. The detector arrangement utilised according to the present invention in embodiments when a reference material 160 is used may also be the same as or different to that shown in FIG. 1.

To achieve a high sensitivity, it may be convenient to measure samples for multiple cycles. Advantageously, the number of cycles may be chosen to be an even number, and the orientation of the sample container may be flipped 180° between alternate cycles. Unavoidably, the X-ray flux on the surface 155 of the sample closest to the target 111 is higher than the flux on the far side of the sample 155, and this leads to a higher level of activation. Combining measurements made with the sample 155 in alternate orientations may improve accuracy by improving the uniformity of the measurement with respect to the distribution of the target element, e.g. gold, within the sample 155.

The measurement, irradiation and cooling times should be chosen to give the maximum possible accuracy for a given time. Straightforward analysis shows that this is achieved when the irradiation and measurement times are equal, and the cooling time is as short as possible. Further, the accuracy shows a broad maximum when the measurement and cooling times are equal to about 2 or 3 times the half-life of the sample isotope. For gold, it is convenient to irradiate and measure samples for about 15-20 seconds. The cooling time may be set by the rate at which samples can be transferred from the respective positions at the irradiation system to the detector/measurement system 140. Using a pneumatic or mechanical automated transfer mechanism, this time may be reduced to about 2.5 seconds or less.

Apparatus calibration may be made with respect to immobile and solid standard samples of accurately known concentration of the target element, e.g. gold. According to the present disclosure, the calibration values may be used for liquid samples with unknown concentration undergoing activation analysis without the requirement of recalibration for liquid standard samples.

The description below refers to embodiments where an optional reference material 160 is used, such as similarly described in WO2015/089580(A1). The following is non-limiting on the present disclosure as a whole and it is understood that the present invention is not limited to requiring simultaneous irradiation of a sample with a reference material.

The sample holder 120 may hold each sample 155 and optional reference material 160. The optional reference material 160 contains at least one reference element. Where gold is a target element in the sample, the use of bromine (Br) as the optional reference element has been found to be useful, as discussed in WO2105/089580. For example, bromine has a gamma ray peak at around 207 keV compared to around 279 keV for gold meaning there is no interference between the signals of the bromine of the reference material and gold in the sample. Bromine has a half-life of 4.86 seconds which is less than that of gold at 7.73 seconds. Bromine is also relatively rare in the earth's crust and is unlikely to be found in the sample. Conveniently, a stable bromine salt such as potassium bromine may be contained within an inert metal shell made from titanium, magnesium or similar. This means that the reference material is able to be reused for an extended period before requiring replacing, thus reducing the frequency at which the apparatus requires recalibrating. Selenium (Se), erbium (Er) or iridium (Ir) may also be selected as the reference element.

The optional reference material 160 may take the form of a disc or circular sheet. The thickness of the reference material 160 may be about 0.1-3.0 mm. Where the reference material 160 includes a powder, it may be conveniently contained in a durable metal housing formed from a metal such as titanium or magnesium that does not have substantial activation reactions. The diameter of the reference material 160 may be smaller than or substantially similar to the diameter of the container containing the sample. During irradiation and measurement, the reference material 160 may be positioned on one flat face of the sample container, such that an axis of the reference material 160 coincides with an axis of the container.

The sample holder 120 may be designed to hold the sample 155 and the reference material 160 in a releasably fixed relation with respect to one another. In this example, the optional reference material 160 has the form of a metal containing an appropriate quantity of potassium bromide.

In one optional embodiment, as shown in FIG. 1, the reference material 160 is placed on the flat surface of the sample container facing the target 111 during the irradiation process. A pair of high-resolution detectors 170, 175 may be used to measure the activation of both the sample 155 and the reference material 160. In other words the detectors 170, 175 measure the gamma rays emitted by both the sample and reference material. The respective detectors 170, 175 may be cylindrical. The detectors 170, 175 may be of similar or larger diameter than the sample container, and may be placed just far enough apart to admit the sample container and reference material for measurement therebetween. In this embodiment, the detectors 170, 175 are large-area semiconductor devices, and may have a FWHM resolution at 279 keV of 1.5 keV or better. It is appreciated that other detectors as known to those skilled in the art could be used, including but not limited to scintillation detectors.

Measurement of the strength of the signal from the reference material 160 in the adjacent detector 170 provides a direct measurement of the number of gamma rays emitted by the reference element. Measurement of the strength of the signal from the reference material 160 in the opposing detector 175 provides a measure of gamma-ray attenuation in the sample, which may be used to supplement, or in place of, a direct measurement of the mass of the sample required to determine the known function of the sample mass that corrects for the difference in attenuation of the reference and target element.

In another possible embodiment (not shown), the optional reference material 160 is placed on a flat surface of the sample container opposite from the solid metal target 111 during irradiation. A single detector may be used to measure the activation of the sample and the reference material. During measurement, the sample 155 is positioned with respect to the detector so that the reference material 160 is immediately adjacent to the detector. In this embodiment, it is necessary to correct for attenuation of the primary X-ray beam before it reaches the reference material 160. This attenuation correction is small, depends primarily on the sample mass, and can be estimated using a Monte Carlo or other computer code in a similar way to a calculation of the function of the sample mass that corrects for the difference in attenuation of the reference and target element.

There is a small dependence of the attenuation correction on the sample composition. In particular, samples such as copper concentrate that contain large concentrations of heavy elements such as iron and copper, attenuate the high-energy X-rays responsible for nuclear activation more strongly than light, rock-forming elements such as silicon and aluminium. This dependence on sample composition could introduce an unwanted calibration bias.

However, with the reference material 160 positioned on the face of the sample 155 opposite from the target 111, X-rays activating nuclei in the reference material must pass through the full thickness of the sample 155. In contrast, X-rays exciting nuclei in the sample 155 must on average pass through only half of the sample thickness. If the reference material 160 is chosen such that the variation, with sample composition, in the attenuation of the X-rays causing activation in said material is lower than the variation in attenuation of the X-rays causing activation in the sample, then the dependence on sample composition can be made to cancel. In particular, when the element being measured is gold, and the reference element is bromine, then the variation with composition in relative activation rates of the sample 155 and the reference material 160 is found to be less than 0.2% for a wide range of sample compositions, including carbon, silica and high-grade copper concentrate. This may mean that a single calibration parameter may be applied to a wide range of different sample types. In either arrangement of the reference material 160 with respect to the sample 155, if the diameter of the reference material 160 is substantially similar to or slightly smaller than the diameter of the sample, then normalising the target element gamma-ray count rate to the reference signal also corrects for small displacements of the X-ray beam with respect to the sample (due to variable position of the sample by the transport; system, or fluctuations in the operation of the LINAC 130) and for displacements of the sample with respect to the detector(s) during measurement. Essentially, these displacements produce a similar effect on both signals and so this potential source of error also largely cancels.

Furthermore, if the position of the reference material 160 is fixed with respect to the sample 155, then accidental displacement of the sample 155 and reference material 155 with respect to either the target 111 or the detector(s) 170, 175 reduces the activation of both the reference element and the gold in the sample proportionally. However, as the target element content is determined from a ratio of the activation levels, this reduction in activation largely cancels. In this way, the analysis may be made relatively more insensitive to inaccuracy in positioning of the sample 155, and may improve accuracy and reduce requirements on the precision of the sample holder 120 and transport system 150.

To achieve a high sensitivity, it may be convenient to measure samples for multiple cycles. Advantageously, the number of cycles may be chosen to be an even number, and the orientation of the sample container may be flipped 180° between alternate cycles. Unavoidably, the X-ray flux on the surface 155 of the sample closest to the target 111 is higher than the flux on the far side of the sample 155, and this leads to a higher level of activation. Combining measurements made with the sample 155 in alternate orientations improves accuracy by improving the uniformity of the measurement with respect to the distribution of the target element, e.g. gold, within the sample 155.

Apparatus calibration is made with respect to immobile and solid standard samples of accurately known concentration of the target element, e.g. gold. The target element signals of unknown concentration samples may be related back directly to these standard calibration values via the constant signal from the reference material. It is anticipated that the same reference material may be used for an extended period, limited only be eventual mechanical or radiation damage and possible loss of the reference element, e.g. Bromine, from the reference material. When it is necessary to replace the reference material, the system can be recalibrated back to the immobile and solid standard samples. According to the present disclosure, the calibration values may be used for liquid samples with unknown concentration undergoing activation analysis without the requirement of recalibration for liquid standard samples.

In accordance with embodiments of the invention, rapid on-site results are able to be obtained for the concentration determination of a target element within a liquid sample.

It will be appreciated by persons skilled in the art that numerous variations and/or modifications may be made to the above-described embodiments, without departing from the broad general scope of the present disclosure. For example, although examples are provided which refer to gold as the target element, it is noted that the invention may also be used to determine the concentration of silver, copper or any other valuable element(s) in a sample.

The present invention may solve the problems of the prior art by the addition of a setting or gelling agent to a liquid sample prior to irradiation and measurement. By rendering the sample substantially solid so that target atoms are immobile during irradiation, measurement and sample transfer, any difficulties of the prior art may be avoided.

The overall activation rate and gamma-ray detection probability for a target element in a sample will depend on the macroscopic properties of the sample. Namely, the material's density and attenuation cross-sections for the incident radiation and emitted gamma-ray radiation. An instrument calibration developed for solid samples with given macroscopic properties can be applied to liquid samples with equivalent properties according to the present invention.

Further, rupturing of the container in which the sample is contained is less likely to lead to spilling or loss of the contents when the liquid sample has been solidified and immobilised. Any toxic, caustic, acidic or radioactive material in the liquid sample is contained when the sample is solidified, meaning it is less likely to cause contamination. A spilled solid sample may also be easier to detect and remove than a liquid sample.

One or more of the following properties may be taken into consideration during the selection of an appropriate gelling or setting agent:
a) the agent should be free from the target element(s) that are to be detected, or any elements that would substantially interfere with the measurement of the target element(s) during activation analysis;
b) the agent should have a large liquid fixing ratio, defined as the mass of the liquid that can be gelled or set divided by the mass of agent required;
c) the agent should preferably have a fast setting reaction speed, preferably taking less than a minute or even more preferably a few seconds to solidify a sample;
d) a set or gelled sample should be stable and substantially unaffected by increase in sample temperature, radiation from the activation source, or any solutes present in the liquid samples;
e) the agent should be of low cost and readily available;
f) the agent should be of low or negligible toxicity; and/or
g) the set or gelled sample should have physical properties that are compatible with respect to ease of handling, disposal and reuse of containers.

### Example

According to an example, the concentration of gold in a liquid sample is to be measured via gamma activation analysis. Gold exhibits an isomeric excitation reaction, resulting in the formation of a short-lived metastable-state within its nucleus that causes the emission of gamma-rays when it relaxes to the ground-state. The reaction of the gold nucleus can be excited using Bremsstrahlung X-rays with end-point energies in the range 6-9 MeV. The following sequence shows the effects of gold excited by high energy X-rays:

$${}^{197} Au -> {}^{197 M} Au ( {t}_{1 / 2} = 7.73 s ) -> {}^{197 M} Au + 279 keV gamma - ray$$

The addition of 20 g of sodium polyacrylate to a 300 mL liquid solution of a gold salt results in the formation of a firm gel that is substantially immobile. This ratio of sodium polyacrylate is found to yield an acceptable gel for gold concentrations up to 300 ppm and concentrations of chloride ions up to 2 wt %.

Sodium polyacrylate, with chemical formula (C₃H₃NaO₂)ₙ contains the elements carbon, hydrogen, sodium and oxygen which do not undergo excitation reactions from X-rays with end-point energies in the range 6-9 MeV. The liquid fixing ratio of 15, ie one part of sodium polyacrylate to 15 parts of liquid sample, means that only a small mass of gelling agent is required for each sample. The gelling reaction between the sodium polyacrylate and the liquid sample occurs rapidly, with the sample reaching its final solidified state in less than one minute. The inventor has established that the gel is stable up to temperatures of at least 60° C., which is significantly higher than occurs during the measurement process, and to X-ray doses up to 100 kGy which again is significantly above the dose used in the irradiation process. Sodium polyacrylate is readily available, low cost and non-toxic. The gelled material can easily be removed from the sample container to enable recycling or reuse of the container, if required.

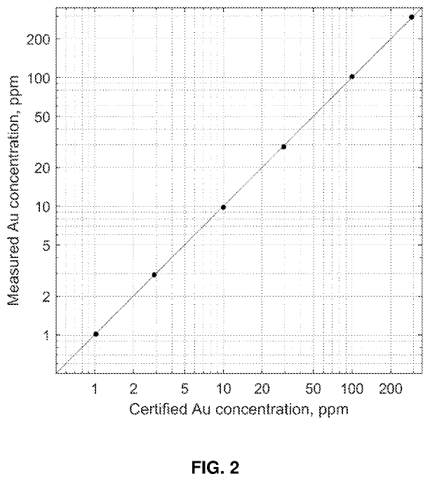

FIG. 2 shows the analysis results obtained for 6 liquid samples prepared from certified standard gold solutions, ie where the concentration of gold was accurately known. Samples with a volume of 300 mL were placed in cylindrical plastic jars and solidified using 20 g of sodium polyacrylate. Samples were then measured via gamma activation analysis using Bremsstrahlung X-rays with an end-point energy of 8.5 MeV as the excitation source. Dual high-resolution germanium detectors measured and counted the 279 keV gamma-rays emitted by activated gold nuclei in the samples. The gamma ray measurements were calibrated using values taken from known solid samples. The measured values for the six different liquid samples were compared to the known gold concentrations, the result being shown in FIG. 2. Excellent correlation and linearity was observed between the certified and measured gold concentrations.

While the invention has been described in conjunction with a limited number of embodiments, it will be appreciated by those skilled in the art that many alternative, modifications and variations in light of the foregoing description are possible. Accordingly, the present invention is intended to embrace all such alternative, modifications and variations as may fall within the spirit and scope of the invention as disclosed.

Any reference to or discussion of any document, act or item of knowledge in this specification is included solely for the purpose of providing a context for the present invention. It is not suggested or represented that any of these matters or any combination thereof formed at the priority date part of the common general knowledge, or was known to be relevant to an attempt to solve any problem with which this specification is concerned.

In this specification, the terms ‘comprises’, ‘comprising’, ‘includes’, ‘including’, or similar terms are intended to mean a non-exclusive inclusion, such that a method, system or apparatus that comprises a list of elements does not include those elements solely, but may well include other elements not listed.

1. A method for performing neutron or gamma activation analysis, comprising:
providing a sample, the sample being at least partially liquid and containing at least one target element;
solidifying the sample;
irradiating the sample to activate the at least one target element within the sample;
detecting a number of gamma rays emitted by the at least one target element within the sample in a measurement; and
determining a value representative of the concentration of the at least one target element in the sample utilising the measurement of gamma rays emitted by the at least one target element and a calibration determined from a solid sample of known composition.

2. The method according to claim 1, wherein the sample is placed in a container prior to solidification, preferably wherein the sample is irradiated within the container.

3. The method according to claim 1, wherein the sample is irradiated by a source of X-rays.

4. The method according to claim 1, wherein the at least partially liquid sample is solidified using a gelling agent or a setting agent.

5. The method according to claim 4, wherein the gelling agent or the setting agent comprises one or more of a superabsorbent polymer, polyacrylate, polyacrylamide, sodium polyacrylate, fumed silica, calcium sulphate, calcium sulphate hemihydrate, or a cement.

6. The method according to claim 1, further comprising:
irradiating a reference material to activate a reference element within the reference material, the reference element having a known concentration within the reference material;
detecting a number of gamma rays emitted by the reference element; and
normalising the measurement of emitted gamma rays from the at least one target element by using the detected number of gamma rays emitted by the reference element,
wherein determining the value representative of the concentration of the at least one target element utilises the normalised measurement.

7. The method according to claim 4, wherein the sample and reference material are irradiated simultaneously and/or wherein the sample and reference material are positioned adjacent to one another prior to irradiation.

8. A method for preparation of an at least partially liquid sample for neutron or gamma activation analysis, comprising:
placing the at least partially liquid sample in a container, the sample comprising at least one target element; and
solidifying the sample within the container.

9. The method according to claim 8, wherein the at least partially liquid sample is solidified using a gelling agent or a setting agent.

10. The method according to claim 9, wherein the gelling agent or the setting agent comprises one or more of a superabsorbent polymer, polyacrylate, polyacrylamide, sodium polyacrylate, fumed silica, calcium sulphate, calcium sulphate hemihydrate, or a cement.

11. The method according to claim 1, wherein the at least partially liquid sample comprises a slurry or process solution from a mineral processing plant.

12. The method according to claim 2, wherein the container is substantially cylindrical and has a diameter in the range from about 50 mm to about 100 mm and a height in the range from about 40 mm to about 70 mm.

13. A system for performing neutron or gamma activation analysis on an at least partially liquid sample, the system comprising:
depositing the at least partially liquid sample in a container, the at least partially liquid sample comprising at least one target element;
a solidification station where the at least partially liquid sample is solidified in the container to form a solidified sample;
an irradiation station where the solidified sample is irradiated and the at least one target element undergoes activation;
a detection station where a number of gamma rays emitted by the activated target element(s) in the solidified sample are measured; and
a calculation system which utilises the measured number of gamma rays emitted by the target element(s) and a calibration determined form a solid sample of known composition to determine a value representative of the concentration of each target element within the sample.

14. The system according to claim 13, further comprising a sample holder adapted to hold the sample container.

15. The system according to claim 13, further comprising a sample transport configured to move the sample between the solidification station and the irradiation station and/or between the irradiation station and the detection station.

16. The system according to claim 13, wherein the at least partially liquid sample is solidified by the addition of a gelling agent or a setting agent, preferably wherein the gelling agent or the setting agent comprises one or more of a superabsorbent polymer, a polyacrylate, a polyacrylamide, sodium polyacrylate, fumed silica, calcium sulphate, calcium sulphate hemihydrate, or a cement.

17. The system according to claim 13, further comprising a reference material comprising a reference element, the reference material positioned adjacent to the sample container when at the irradiation station and when at the detection station, and wherein the calculation system utilises a measurement of gamma rays emitted by the reference element in the determination of the value representative of the concentration of each target element within the sample.

18. The system according to claim 13, further comprising a computer configured to control a functioning of at least one of the solidification station, the irradiation station, the detection station, and movement of the sample between each station.

19. The system according to claim 13, wherein the irradiation station comprises a linear accelerator that generates a beam of high energy electrons and a solid metal target that produces X-rays when the beam of electrons impinges on a surface of the solid metal target.

20. The system according to claim 13, wherein the detection system comprises at least one radiation detector, preferably wherein one or more of:
the at least one detector is a high-resolution semiconductor detector or scintillator detector;
the at least one detector comprises two detectors configured to be positioned on opposite sides of the sample container in use; and/or
the or each detector is cylindrical.
